(19) United States
(12) Patent Application Publication
(10) Pub. No.: US 2024/0162655 A1
(43) Pub. Date: May 16, 2024

(54) SELF-RESTORING CONNECTOR

(71) Applicant: Hirose Electric Co., Ltd., Yokohama (JP)

(72) Inventor: Kentaro ISHII, Yokohama (JP)

(21) Appl. No.: 18/502,286

(22) Filed: Nov. 6, 2023

(30) Foreign Application Priority Data
Nov. 8, 2022 (JP) 2022-178842

(51) Int. Cl. H01R 13/631; H01R 12/71; H01R 13/502; H01R 13/639; H01R 13/6581

(52) U.S. Cl. CPC H01R 13/631; H01R 12/712; H01R 13/502; H01R 13/639; H01R 13/6581

(57) ABSTRACT

The inventive self-repairing connector 1 is a self-repairing connector which, along with mating with a counterpart connector 20 and placing respective terminals 10, 24 in electrical communication, is adapted to self-repair continuity faults between the respective terminals, said connector comprising a housing 6 and terminal members 10 that make contact with the counterpart terminals 24 via points of terminal contact 10b, wherein a holding portion 14 holding a dispersion C of metal nanoparticles B and fluid communication portions 12 effecting fluid communication between the holding portion 14 and the terminal members 10 in the vertical direction are formed in the housing, and the dispersion of metal nanoparticles held in the holding portion is dropped onto the points of terminal contact upon occurrence of a continuity fault.

### CROSS-REFERENCE TO RELATED APPLICATIONS

This application claims priority to Japanese Patent Application No. 2022-178842, filed Nov. 8, 2022, the contents of which are incorporated herein by reference in its entirety for all purposes.

### TECHNICAL FIELD

The present invention is concerned with a self-repairing connector and in particular relates to a self-repairing connector which, along with mating with a counterpart connector and placing respective terminals in electrical communication with each other, is adapted to self-repair continuity faults between the respective terminals.

### RELATED ART

A variety of connector-related technologies designed to place respective terminals in contact and electrical communication via electrical interconnections by inserting a cable connector/plug connector into a counterpart connector (e.g., a board-mounted “receptacle connector”) have been known in the past. For example, in Patent Document 1, there are provided a wire connector and a board connector that mates with this wire connector, the wire connector has a housing formed of an insulating material such as synthetic plastics and the like, a plurality of metal terminals loaded into the housing, and a shell formed of an electrically conductive metal sheet that covers the periphery of the housing, the board connector has a counterpart housing formed of an insulating material such as synthetic plastics and the like, a plurality of metal counterpart terminals loaded into this counterpart housing, and a counterpart shell formed from an electrically conductive metal sheet that covers the periphery of the counterpart housing, and this wire connector and board connector are adapted to place the terminals of the wire connector and the terminals of the board connector in contact and electrical communication by mating with each other.

In addition, self-repairing wiring, which is configured to permit self-repair by covering electrical wiring placed on a predetermined substrate with a liquid/fluid containing dispersed electrically conductive nanoparticles (mainly metal nanoparticles) in advance and, upon appearance of a crack in the electrical wiring, making use of the electric fields and so-called dielectrophoretic forces generated in the region of the crack to cause the electrically conductive nanoparticles from the fluid to aggregate in the region of the crack while being fused and interlinked, is known (e.g., Patent Document 2) as self-repair technology for on-board electrical wiring.

### PATENT DOCUMENTS

[Patent Document 1]
Japanese Patent Application Publication No. 2018-120686
[Patent Document 2]
Japanese Patent Publication No. 6,507,148

### SUMMARY

### Problems to be Solved

Incidentally, so-called “connectors” are used in extreme environments that are difficult to access for operators, such as, for instance, nuclear power plants, facilities deployed on the seabed, satellite facilities in outer space, and the like. If a continuity fault occurs, for instance, because of faulty contacts in a connector used in such an extreme environment, there is a chance that it will be a problem because the operator won't be able to immediately repair the connector or replace the board, and the continuity fault will have to be left unchecked for an extended period of time. Accordingly, in recent years, especially as concerns connectors used in such extreme environments and, in addition, connectors for consumer use, there has emerged the possibility that a need will arise for self-repairing connectors that perform temporary or semi-permanent self-repair in the event of a continuity fault. In particular, such demand has arisen in connection with specialized power supply circuitry in which the regulation/stability of alternating voltages and frequencies is of importance.

The present invention, which was devised to eliminate the above-described issues, has the object of providing a self-repairing connector capable of self-repairing a continuity fault if a continuity fault occurs at a point of terminal contact between terminals.

### Technical Solution

In order to achieve the above-mentioned object, the inventive self-repairing connector is a self-repairing connector which, along with mating with a counterpart connector and placing respective terminals in electrical communication, is adapted to self-repair continuity faults between the respective terminals, said connector comprising a housing formed of a non-conductive material and terminal members having one end thereof retained in the housing and making contact with the terminals of the counterpart connector via points of terminal contact, wherein a holding portion holding a dispersion of metal nanoparticles is formed in the housing, fluid communication portions effecting fluid communication between the holding portion and the terminal members are formed in the housing, and the dispersion of metal nanoparticles held in the holding portion is dropped onto the points of terminal contact in a predetermined case.

### Technical Effect

With the use of the inventive self-repairing connector, it is possible to self-repair a continuity fault in the event of a continuity fault occurring at a point of terminal contact between terminals.

### BRIEF DESCRIPTION OF THE DRAWINGS

FIG. 1 is a perspective view of the connector according to Embodiment 1 of the present invention.

FIG. 2 is a partial cross-sectional perspective view used mainly to describe the microcapsule-holding portion, terminal members, and slit portions holding the terminal members in the connector according to Embodiment 1 shown in FIG. 1.

FIG. 3 is a front view of the connector according to Embodiment 1.

FIG. 4 is a cross-sectional view of the connector according to Embodiment 1 as seen along line A-A shown in FIG. 3.

FIG. 5 (A) is a perspective view of the receptacle connector with which the connector according to Embodiment 1 is mated, and FIG. 5 (B) is a front view of the receptacle connector with which the connector according to Embodiment 1 is mated.

FIG. 6 is a perspective view illustrating a state in which the connector according to Embodiment 1 is mated with the receptacle connector mounted on a board.

FIG. 7 (A) is a perspective view illustrating a terminal of the connector according to Embodiment 1 along with a receptacle terminal.

FIG. 7 (B) is a perspective view illustrating a terminal of a connector according to a variation of Embodiment 1 along with a receptacle terminal.

FIG. 8 is a conceptual view of a microcapsule held in the connector according to Embodiment 1.

FIG. 9 is a perspective view illustrating, in a mated state, a state of contact between a terminal member of the connector according to Embodiment 1 and a terminal of the receptacle connector, shown together with the microcapsule-holding portion.

FIG. 10 is a cross-sectional view, as seen from the same position as line A-A of FIG. 3, illustrating, in a mated state, a state of contact between a terminal member of the connector according to Embodiment 1 and a terminal of the receptacle connector, shown together with the microcapsule-holding portion.

FIG. 11 is a cross-sectional view, as seen from the same position as line A-A of FIG. 3, illustrating a state of contact between a terminal member of a connector with a film heater according to a variation of Embodiment 1 and a terminal of the receptacle connector, shown together with the microcapsule-holding portion.

FIG. 12 is a perspective view illustrating, similar to the explanatory FIG. 9, a state in which the dispersion of metal nanoparticles used in the connector according to Embodiment 1 is dropped onto a point of terminal contact.

FIG. 13 (A) is a perspective view used to describe heat transfer in the connector according to Embodiment 1, and FIG. 13 (B) is a perspective view used to describe heat transfer in a connector according to a variation of Embodiment 1.

FIG. 14 (A) is a schematic cross-sectional view, as seen from the same position as line A-A of FIG. 3, diagrammatically illustrating the configuration of the housing, holding portion and dispersion-dropping structure of the connectors according to Embodiment 2 and Embodiment 3 of the present invention, and FIG. 14 (B) is a schematic cross-sectional view illustrating, similar to the explanatory view of FIG. 14 (A), the operation of the connectors according to Embodiments 2 and 3 of the present invention shown in FIG. 14 (A).

FIG. 15 (A) is a schematic cross-sectional view, as seen from the same position as line A-A of FIG. 3, diagrammatically illustrating the configuration of the housing, holding portion and dispersion-dropping structure of a connector according to Embodiment 4 of the present invention, and FIG. 15 (B) is a schematic cross-sectional view illustrating, similar to the explanatory view of FIG. 15 (A), the operation of the connector according to Embodiment 4 of the present invention shown in FIG. 15 (A).

### DETAILED DESCRIPTION

Below, embodiments of the present invention will be described with reference to drawings.

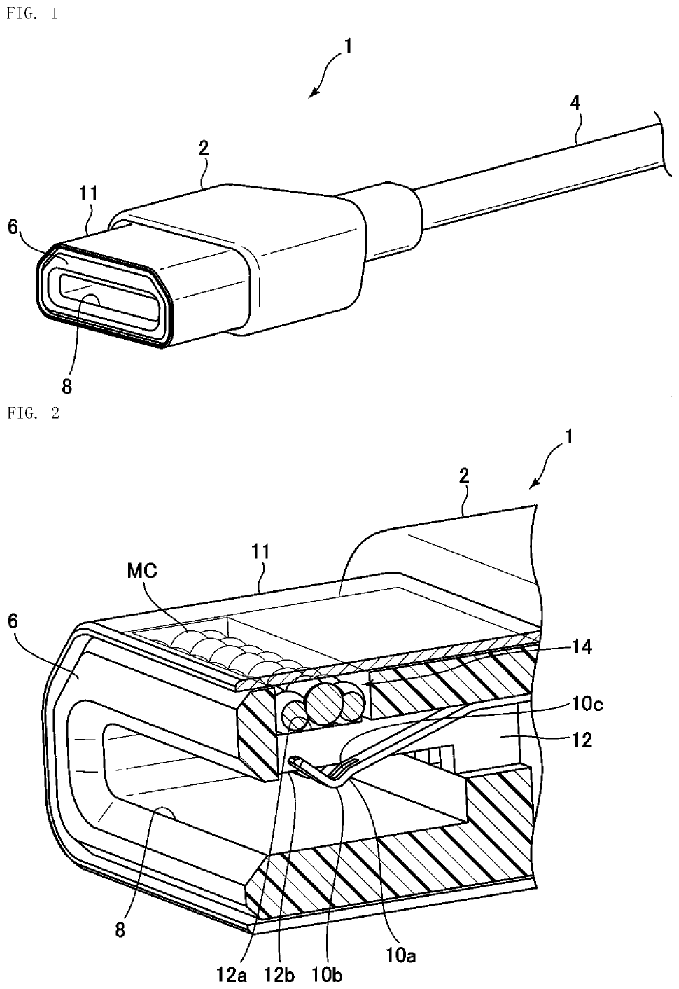

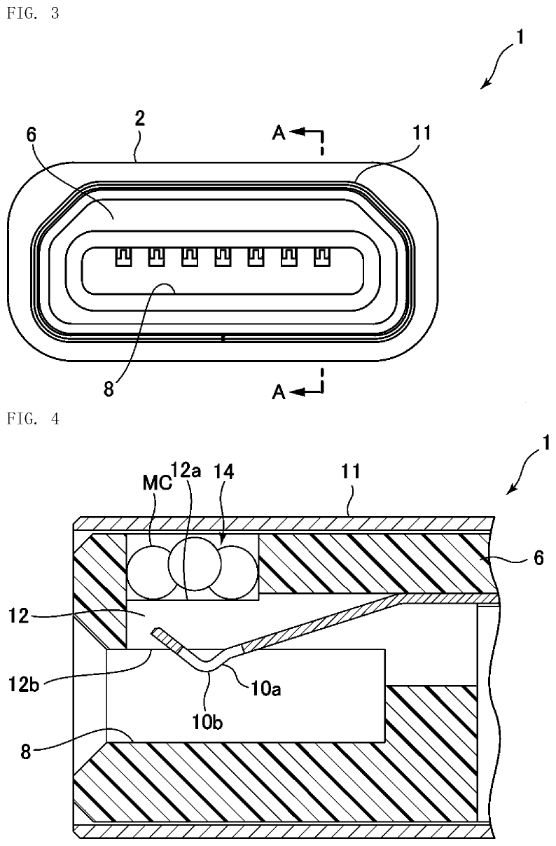

The overall configuration of the self-repairing connector according to Embodiment 1 of the present invention will first be described with reference to FIGS. 1 to 4. FIG. 1 is a perspective view of the connector according to Embodiment 1 of the present invention, FIG. 2, which is a partial cross-sectional perspective view used mainly to describe the microcapsule-holding portion, terminal members, and slit portions holding the terminal members in the connector according to Embodiment 1 shown in FIG. 1, shows a portion thereof in a semi-transparent manner in order to describe how the microcapsules are held, FIG. 3 is a front view of the connector according to Embodiment 1, and FIG. 4 is a cross-sectional view of the connector according to Embodiment 1, as seen along line A-A shown in FIG. 3.

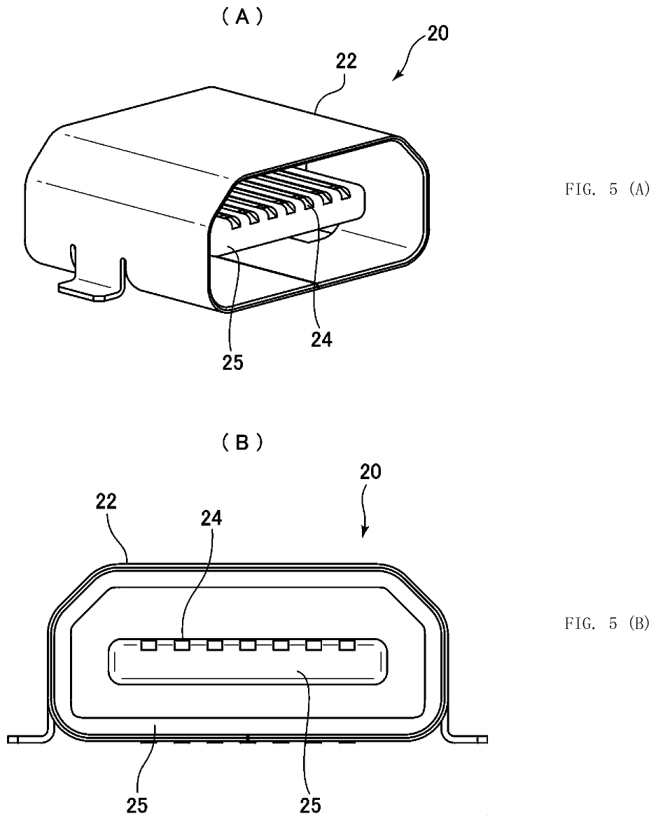

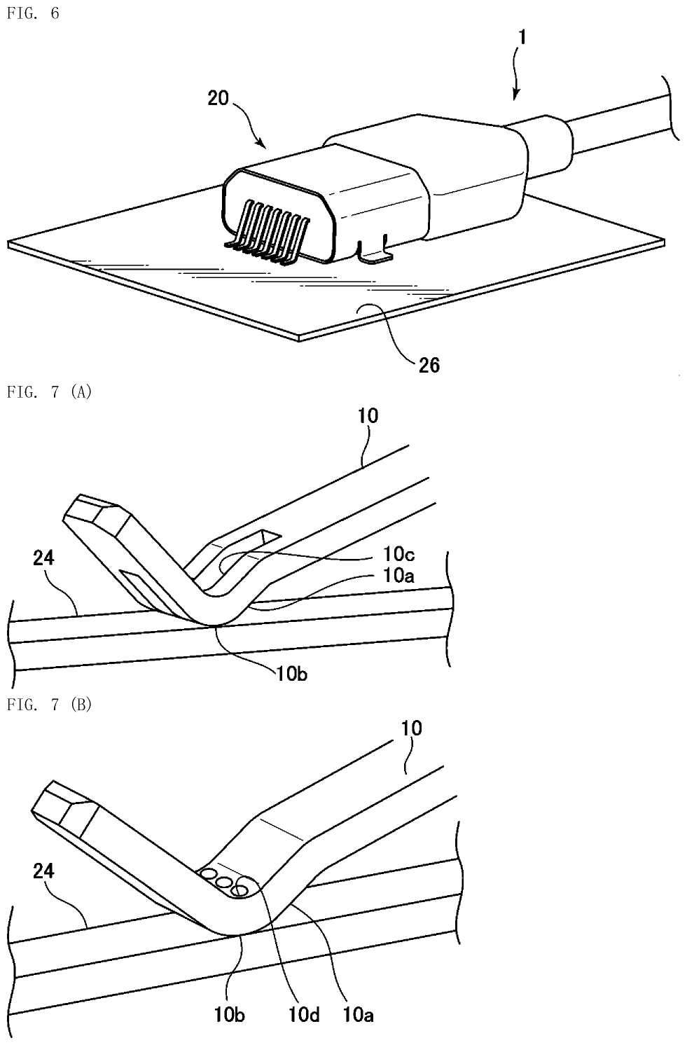

First, as shown in FIG. 1, the connector (self-repairing connector) 1 according to Embodiment 1 of the present invention, which is a plug connector (cable connector) 1 adapted to be mated with the hereinafter-described receptacle connector 20, i.e., the counterpart connector (see FIGS. 5, 6, etc.), has a housing 2 made of plastics intended mainly for the handling of the connector 1 by an operator, a cable 4 extending rearwardly from the housing 2, and a terminal housing (referred to as “housing” hereinbelow) 6 made of plastics, i.e., a non-conductive material, and an insertion portion 8 intended for mating with the hereinafter-described receptacle connector 20 is formed in the housing 6 (see FIG. 5).

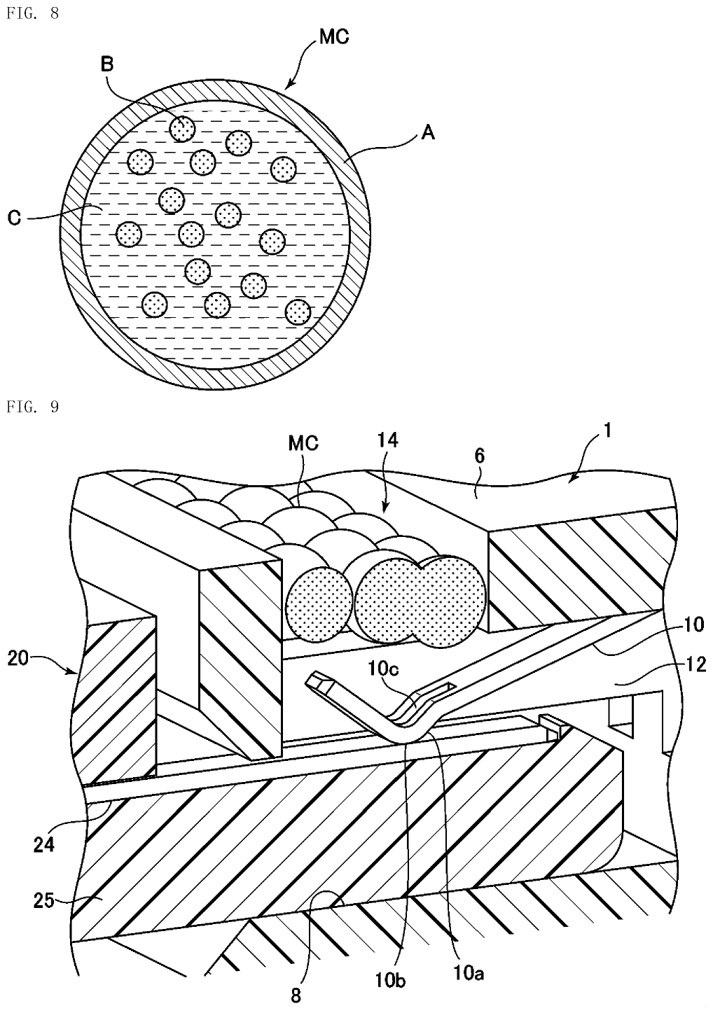

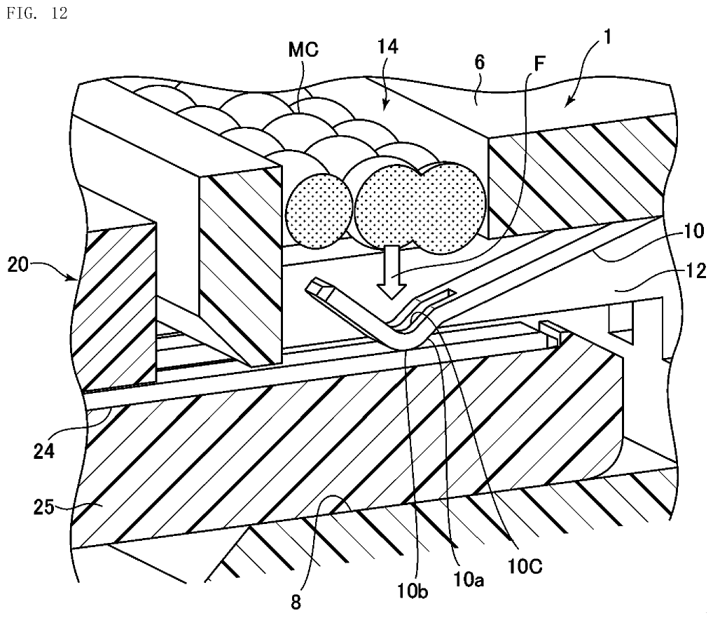

Further, as shown in FIGS. 2 and 3, multiple terminal members (terminals) 10 partially protruding into the insertion portion 8 are provided in the housing 6. Each of these terminal members 10 extends along the axial direction of the connector 1 (along the direction of mating with the receptacle connector 20). The distal end portions of these terminal members 10 are curved with respect to the direction in which the terminal members 10 extend, such that downwardly curving curved portions 10a are formed in the distal end portions of the respective terminal members 10. Points of terminal contact 10b, i.e., points of contact with the terminals 24 of the hereinafter-described receptacle connector 20 (inter-terminal contact sections), are formed by these curved portions 10a (see FIGS. 7, 9, etc.).

In addition, each of the multiple terminal members 10, which have their ends opposite to the distal end portions thereof secured in and supported by, in a cantilever fashion, the housing 6, is adapted to be placed in resilient contact and electrical communication with a terminal 24 of the receptacle connector 20 via a point of terminal contact 10b.

In addition, a shell 11 made up of an electrically conductive metal sheet covering the outer periphery of the housing 6 is provided in the housing 6 in order to provide EMI shielding for signals passing therethrough.

Further, as shown in FIGS. 2 and 4, multiple slits (slit portions) 12 holding these terminal members 10 by sandwiching them on the left and right are formed in the housing 6. The slits 12 extend in the axial direction of the connector 1 in a manner to accommodate the terminal members 10 in their entirety while extending therethrough in the vertical direction.

On the other hand, a microcapsule-holding cavity (holding portion) 14 capable of holding the hereinafter-described multiple microcapsules MC is formed above the multiple slits 12 in the housing 6 and adjacent the multiple slits 12. This microcapsule-holding cavity 14 is provided at a location spaced a predetermined distance from the terminal members 10 in a manner preventing it from affecting the resilience of the terminal members 10.

With these arrangements, the slits 12 have their upper opening portions 12a placed in communication with the cavity 14 and their lower opening portions 12b placed in communication with the insertion portion 8, thereby forming the slits 12 as vertical fluid communication portions 12.

Further, as shown in FIGS. 2 and 4, the microcapsule-holding cavity 14 is sealed by the above-described shell 11. It should be noted that a cover member or a film member may be provided on the upper face of the cavity 14 as well as on the lower face of the shell 11 in order to seal the microcapsules inside the cavity 14 and trap them within the cavity 14, or in order to prevent corrosion of the shell 11. It should be noted that in FIG. 2 a portion of the shell 11 is depicted in a semi-transparent manner and the cover member is omitted in order to show how the microcapsules MC are held. The cover member or film member is formed of the same plastic as the housing 6.

The overall configuration of the receptacle connector with which the connector according to Embodiment 1 of the present invention is mated will now be described with reference to FIGS. 5 and 6. FIG. 5 (A) is a perspective view of the receptacle connector with which the connector according to Embodiment 1 is mated, FIG. 5 (B) is a front view of the receptacle connector with which the connector according to Embodiment 1 is mated, and FIG. 6 is a perspective view illustrating a state in which the connector according to Embodiment 1 is mated with the receptacle connector mounted on a board.

First, as shown in FIGS. 5 (A) and 5 (B), the receptacle connector 20 mating with the terminal members 10 comprises a shell 22 made up of an electrically conductive metal sheet covering the outer periphery of the housing 6 in order to provide EMI shielding for signals passing therethrough, and multiple metal receptacle terminal members (referred to as “terminals” hereinbelow) 24, with both of them attached to a housing 25 made of plastics, i.e., a non-conductive material. In the present embodiment, as shown in FIG. 6, the receptacle connector 20 is mounted on a board 26. It should be noted that, for the sake of convenience, only a portion of the board 26 is illustrated in FIG. 6.

The multiple terminals 24 of the receptacle connector 20 are disposed in alignment with the multiple terminal members 10 of the above-described connector 1 and, when the connector 1 is mated with the receptacle connector 20 as shown in FIG. 6, the terminals 24 and terminal members (terminals) 10, as shown in the hereinafter-described FIGS. 7 and 9, are adapted to be placed in contact and electrical communication at the points of terminal contact 10b.

The configuration of the terminal members 10 of the connector 1 according to Embodiment 1 and a variation thereof will now be described with reference to FIG. 7 (A) and FIG. 7 (B). FIG. 7 (A) is a perspective view illustrating a terminal of the connector according to Embodiment 1 along with a receptacle terminal, and FIG. 7 (B) is a perspective view illustrating a terminal of a connector according to a variation of Embodiment 1 along with a receptacle terminal.

First, as shown in FIG. 7 (A), slit portions 10c serving as fluid communication paths are formed in the terminal members 10 according to the present embodiment at locations centered on the points of terminal contact 10b of the curved portions 10a. Such slit portions 10c, which are apertures of a rectangular cross-section, are formed in all the multiple terminal members 10.

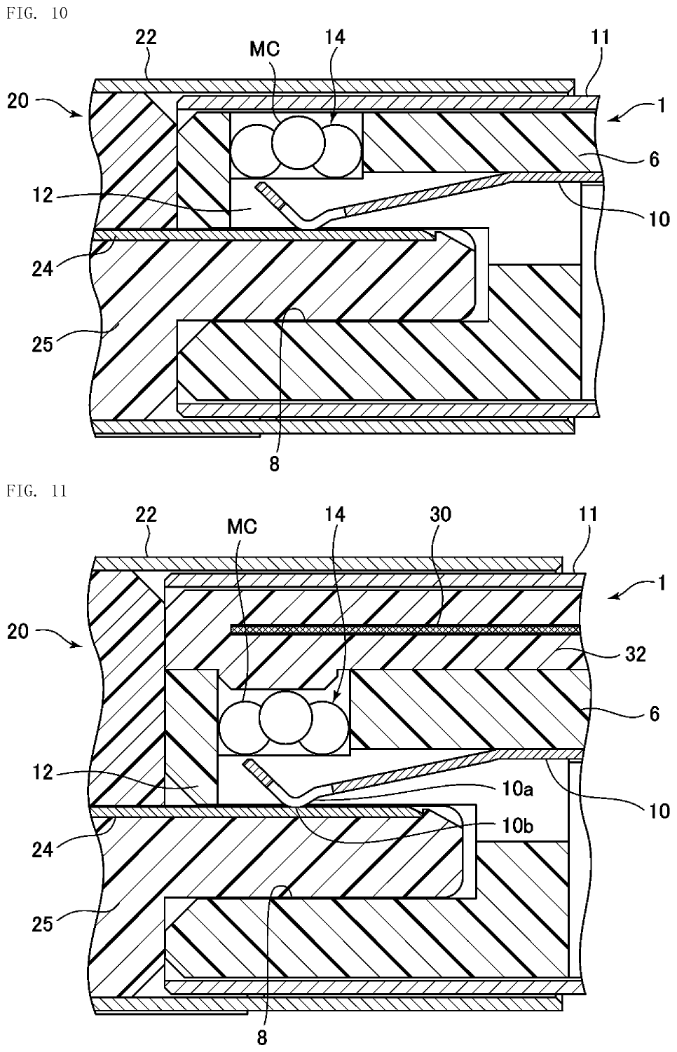

As described below, such slit portions 10c are formed for dropping the dispersion C of metal nanoparticles B encapsulated in the microcapsules MC whose membrane A has disintegrated (see FIG. 8) directly onto the points of terminal contact 10b in order to coat the terminals 10 and terminals 24. It should be noted that the terminal members 10 may have multiple slit portions 10c formed therein. For example, in order to drop the dispersion of metal nanoparticles directly onto the points of terminal contact 10b, at least two of them may be formed inwardly in the width direction of the terminal members 10 or on both lateral faces of the terminal members 10.

On the other hand, as shown in FIG. 7 (B), multiple apertures 10d of a circular cross-section are formed at the location of the point of terminal contact 10b in a terminal member 10 according to a variation of the present embodiment. These apertures 10d are also formed for dropping the dispersion of metal nanoparticles directly onto the point of terminal contact 10b. It should be noted that there may be a single aperture 10d of such a circular cross-section.

The microcapsules used in the connector 1 of Embodiment 1 will now be described with reference to FIG. 8. FIG. 8 is a conceptual view of a microcapsule held in the connector according to Embodiment 1.

The microcapsules MC shown in FIG. 8 are a means of dropping the dispersion C of metal nanoparticles B onto the points of terminal contact 10b and coating them. As shown in FIG. 8, a microcapsule MC comprises a spherical membrane A, with lubricant C containing dispersed metal nanoparticles B encapsulated inside this membrane A. In the present embodiment, the membrane A of this microcapsule MC is adapted to break down in response to temperature. That is to say, materials that break down at a predetermined temperature are used and, as described below, the temperature of the membrane A is raised by application of heat in order to disintegrate it, as a result of which the encapsulated dispersion C of metal nanoparticles B is dropped onto the points of terminal contact 10b, thereby coating the locations of the points of terminal contact 10b and locations around the periphery of the points of terminal contact 10b near the surface of contact of the terminals 10, 24. In the present embodiment, a lubricant (lubricating oil) is used as the liquid C in which the metal nanoparticles are dispersed. It should be noted that the dispersion C may be other than a lubricant.

Here, the size of the microcapsules MC is, for example, 1 μm to 100 μm in diameter or greater, e.g., 0.5 mm to 5 mm. If the diameter of the microcapsules MC is smaller than the width of the slits 12 of the housing 6, a retaining member such as, for example, a mesh-like film member or the like capable of passing the dispersion while retaining the microcapsules MC may be provided in order to prevent the microcapsules MC held within the microcapsule-holding cavity 14 from falling into the slit 12.

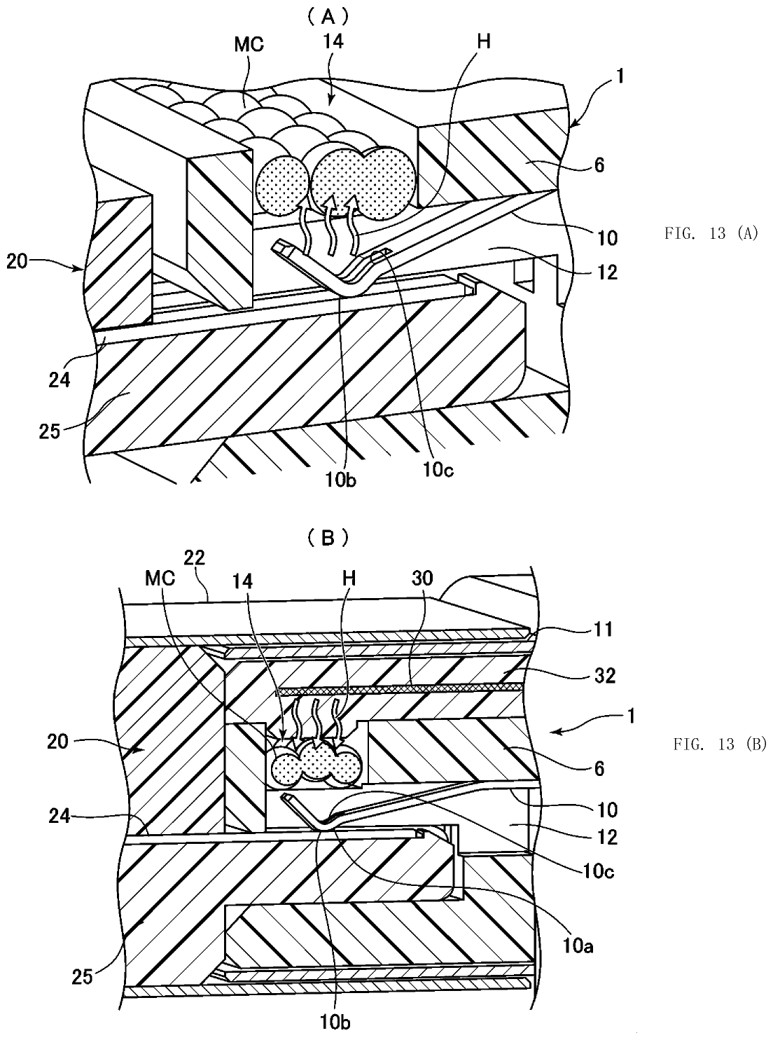

The state of contact between the terminal members 10 of the connector 1 according to Embodiment 1 and the terminals 24 of the receptacle connector 20, and the relative position of the points of terminal contact 10b and the microcapsule-holding cavity 14, in a state in which the connector 1 is mated with the receptacle connector 20, will now be described with reference to FIGS. 9 to 11. FIG. 9 is a perspective view illustrating, in a mated state, a state of contact between a terminal member of the connector according to Embodiment 1 and a terminal of the receptacle connector, shown together with the microcapsule-holding portion, FIG. 10 is a cross-sectional view, as seen from the same position as line A-A of FIG. 3, illustrating, in a mated state, a state of contact between a terminal member of the connector according to Embodiment 1 and a terminal of the receptacle connector, shown together with the microcapsule-holding portion, and FIG. 11 is a cross-sectional view, as seen from the same position as line A-A of FIG. 3, illustrating a state of contact between a terminal member of a connector with a film heater according to a variation of Embodiment 1 and a terminal of the receptacle connector, shown together with the microcapsule-holding portion.

First, as shown in FIGS. 9 and 10, when the connector 1 is mated with the receptacle connector 20, the housing 6 and shell 11 are inserted into the receptacle connector 20 while the housing 25 and terminals 24 on the receptacle side are introduced into the insertion portion 8 of the connector 1. In this state, the terminal members 10 and terminals 24 make contact via the points of terminal contact 10b such that the respective terminals are placed in electrical communication. In the present embodiment, in such a mated state, the above-described cavity 14 is adapted to be disposed above the points of terminal contact 10b.

Further, in the connector 1 according to a variation of Embodiment 1 shown in FIG. 11, a film heater 30 intended for applying heat to the microcapsules MC is provided at a location inside the housing 6 and adjacent to and overlying the cavity 14. This film heater 30 covers at least the entire space above the cavity 14 or, as long as enough heat can be applied to the microcapsules MC, may cover a portion of the space above the cavity 14. The film heater 30 is incorporated into a plastic cover member 32 that covers the cavity 14. Since other configurations of the connector 1 are similar to the present embodiment described above, further description thereof is omitted.

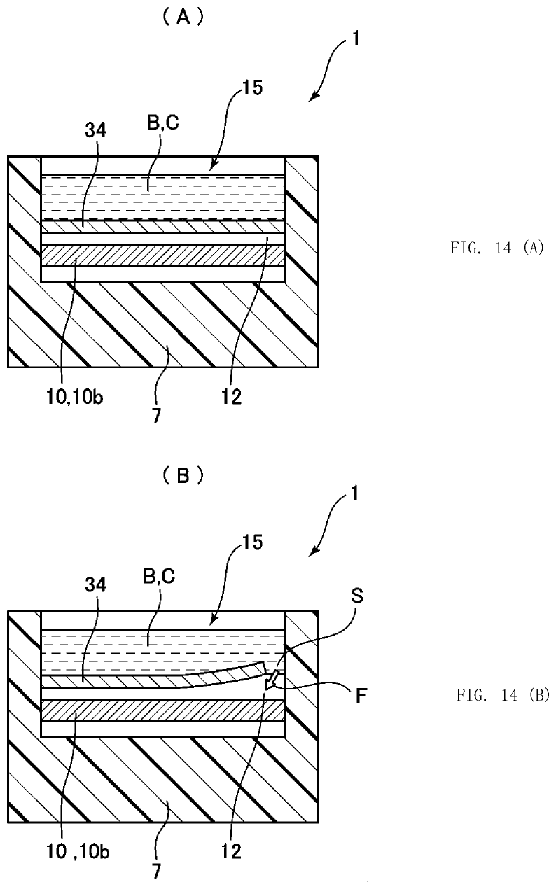

The self-repairing action of the connector according to Embodiment 1 of the present invention and a variation thereof, as well as a method therefor, will now be described with reference to FIGS. 12 and 13 (A) to 13 (B). FIG. 12 is perspective view illustrating, similar to the explanatory FIG. 9, a state in which the dispersion of metal nanoparticles used in the connector according to Embodiment 1 is dropped onto a point of terminal contact, FIG. 13 (A) is a perspective view used to describe heat transfer in the connector according to Embodiment 1, and FIG. 13 (B) is a perspective view used to describe heat transfer in a connector according to a variation of Embodiment 1.

First, in Embodiment 1 of the present invention and a variation thereof, the membrane A of the microcapsules MC held in the microcapsule-holding cavity 14 is disintegrated by heat and the lubricant C containing dispersed metal nanoparticles B, which is released as a result of disintegration by heat, is dropped onto the point of terminal contact 10b below as shown by arrow F in FIG. 12, thereby coating the terminal member 10 and terminal 24 at the location of the point of terminal contact 10b and around the periphery thereof.

The lubricant C containing dispersed metal nanoparticles B is dropped in the direction indicated by arrow F in FIG. 12 and supplied to the points of terminal contact 10b via the slits 12 formed under the cavity 14 as well as the slit portions 10c (see FIG. 7 (A)) or apertures 10d (see FIG. 7 (B) formed in the terminal members 10.

If, in the present embodiment, the points of terminal contact 10b are maintained in adequate contact here and if no continuity faults occur, the microcapsules MC are still held in the cavity 14.

On the other hand, when a faulty contact or a continuity fault occurs at the point of terminal contact 10b in connection with certain factors (e.g., corrosion, etc.), the point of terminal contact 10b is to self-repair in the following manner.

When heat is applied to the microcapsules MC inside the cavity 14 as described hereinbelow with reference to FIG. 13 upon occurrence of a continuity fault at the point of terminal contact 10b, the lubricant C containing dispersed metal nanoparticles B is supplied (dropped) via the slits 12 and apertures 10c (10d) to the point of terminal contact 10b and coats the terminal member 10 and terminal 24 at the location and around the periphery of the point of terminal contact 10b as described above. In such a coated state, an electric field is generated in the lubricant C used for coating by the electric current flowing through the terminal member 10 and terminal 24 on the receptacle side. In addition, so-called “dielectrophoretic forces” act on the metal nanoparticles B in the dispersion C having such an electric field generated therein, and the metal nanoparticles B are aggregated around the periphery of the point of terminal contact 10b by these dielectrophoretic forces.

The multiple aggregated metal nanoparticles B then link the terminals 10, 24 together and, under the action of heat generated as a consequence of the electric current flowing through each terminal 10, 24, the multiple metal nanoparticles B stick to one another, thereby bridging and interlinking the terminals 10, 24 with the metal nanoparticles B and, as a result, restoring continuity. In other words, the interlinked metal nanoparticles B have a high resistance value and, as the electric current flows therethrough, heat is generated by the resistance of the metal nanoparticles B, with the metal nanoparticles B becoming fused and interlinked by the heat into a unitary piece of metal through which the electric current flows. These phenomena represent the so-called “self-repairing” action in the embodiments of the present invention and variations thereof. It should be noted that once the metal nanoparticles B have been interlinked, the electric field generated in the dispersion C disappears, the dielectrophoretic forces cease to act, and the self-repairing action terminates.

Further, as shown in FIG. 13 (A), the present embodiment makes use of the heat generated at the point of terminal contact 10b in order to raise the temperature of the microcapsules MC held within the cavity 14. In this process, a continuity fault between the terminals 10, 24 raises the value of contact resistance at the point of terminal contact 10b and generates heat, whereupon, as shown in FIG. 13 (A), this heat H is transferred to the microcapsule-holding cavity 14, as a result of which the microcapsules MC are heated to a predetermined temperature, which breaks down the membrane A, thereby dropping the lubricant C containing dispersed metal nanoparticles B onto the point of terminal contact 10b.

In this manner, in the present embodiment, upon occurrence of a continuity fault at the point of terminal contact 10b, the heat generated at the point of terminal contact 10b as a consequence of this continuity fault is transferred to the cavity 14, thereby causing the membrane A of the microcapsules MC held therein to disintegrate while causing the released dispersion C of metal nanoparticles B to be dropped via the slits 12 of the housing 6 and the apertures 10c (10d) of the terminal members 10 onto the point of terminal contact 10b. In accordance with the present embodiment, the microcapsules MC can be disintegrated without using additional mechanical components.

Further, as shown in FIG. 13 (B), a variation of the present embodiment makes use of the heat generated by operating the above-described film heater 30 shown in FIG. 11 in order to raise the temperature of the microcapsules MC held within the cavity 14. In this process, as shown in FIGS. 11 and 13 (B), the film heater 30 is provided at a location adjacent to and overlying the cavity 14 and, as shown with symbol “H” in FIG. 13 (B), its heat is transferred to the cavity 14, as a result of which the microcapsules MC are heated to a predetermined temperature, which breaks down the membrane A, thereby causing the lubricant C containing dispersed metal nanoparticles B to be dropped onto the point of terminal contact 10b.

Thus, in a variation of the present embodiment, as a result of providing a film heater 30 installed in the housing 6 and transferring its heat to the cavity 14, the membrane A of the microcapsules MC held therein disintegrates and the released dispersion C of metal nanoparticles B is dropped onto the point of terminal contact 10b via the slits 12 of the housing 6 and the apertures 10c (10d) of the terminal members 10.

It should be noted that the film heater 30 uses a predetermined well-known circuit arrangement incorporated into the connector 1 in order to detect an increase in the value of resistance due to a continuity fault at the point of terminal contact 10b, and the operation of the film heater 30 is controlled in a well-known manner in response to the detected value. In accordance with this variation of the present embodiment, controlling the amount of the heat generated by the film heater 30 makes it possible to more reliably control the disintegration of the microcapsules MC. In addition, the microcapsules MC can be disintegrated without using mechanical attachments.

The self-repairing connectors according to Embodiments 2 and 3 of the present invention will now be described with reference to FIGS. 14 (A) and 14 (B0. FIG. 14 (A) is a schematic cross-sectional view, as seen from the same position as line A-A of FIG. 3, diagrammatically illustrating the configuration of the housing, holding portion and dispersion-dropping structure of the connectors according to Embodiment 2 and Embodiment 3 of the present invention, and FIG. 14 (B) is a schematic cross-sectional view illustrating, similar to the explanatory view of FIG. 14 (A), the operation of the connectors according to Embodiment 2 and Embodiment 3 of the present invention shown in FIG. 14 (A).

The description hereinbelow will focus only on points of difference from Embodiment 1 described above, and configurations in common with Embodiment 1 will be described using the same reference numerals.

First, as shown in FIG. 14 (A), in Embodiment 2 of the present invention, a dispersion holding cavity (holding portion) 15, whose dimensions and shape are similar to Embodiment 1 described above, is formed in the housing 7. The lubricant (dispersion) C containing dispersed metal nanoparticles B is stored directly in this cavity 15, such that the dispersion C is held in the cavity 15.

In this Embodiment 2, one bimetallic member 34 is provided on the lower face of the cavity 15, i.e., on the bottom face of the cavity 15 including the upper edges of the above-described multiple slits 12. This bimetallic member 34 is formed to cover the entire bottom face of the cavity 15 while keeping the lubricant C containing dispersed metal nanoparticles B within the cavity 15 (in a manner preventing downward leakage).

It should be noted that, as a variation, multiple bimetallic members 34 may be provided on the bottom face of the cavity 15 as long as the lubricant C can be kept in a manner preventing downward leakage.

In addition, as a variation, a bimetallic member 34 may be provided in each of the multiple slits 12 serving as fluid communication portions in a manner preventing downward leakage of the lubricant C, such that the lubricant C is kept within the cavity 15.

In addition, in Embodiment 3 of the present invention, a shape memory alloy member 34 may be used instead of the bimetallic member 34; since its configuration, including its placement and shape, is identical to the bimetallic member 34 of Embodiment 2 described above, further description thereof is omitted. It should be noted that since the configurations illustrated in FIGS. 14 (A) and 14 (B) are identical, for ease of discussion, the bimetallic member 34 and shape memory alloy member 34 are illustrated using the same reference numerals.

The operation of Embodiments 2 and 3 will now be described with reference to FIG. 14 (B).

First, Embodiment 2, which makes use of a bimetallic member 34 as part of the dispersion-dropping structure, makes use of the heat generated as a result of an increase in the value of contact resistance at the point of terminal contact 10b in response to a continuity fault between the terminals 10, 24, as described above with reference to FIG. 13 (A).

In the case of Embodiment 2, along with being transferred to the cavity 15 (e.g., as shown in FIG. 13 (A)), the heat generated at the point of terminal contact 10b is transferred to the bimetallic member 34, at which point the bimetallic member 34, due to its properties, is displaced (deformed) as shown in FIG. 14 (B).

When the bimetallic member 34 is displaced, a gap S, such as the one illustrated in the drawing, appears between the bimetallic member 34 and the cavity 15 or, in a variation, between the bimetallic member 34 and the slit 12. The lubricant C containing dispersed metal nanoparticles B, which has been held in the cavity 15, flows into the slit 12 below through this gap S and is then dropped onto the point of terminal contact 10b of the terminal 10.

As a result, as described above in Embodiment 1, the metal nanoparticles B are fused under the action of the “dielectrophoretic forces,” etc., and interlinked into a unitary piece of metal, through which the electric current flows, thereby making it possible to effect a “self-repairing” action.

On the other hand, in Embodiment 3, which makes use of a shape memory alloy member 34 as part of the dispersion-dropping structure, an increase in the value of resistance due to a continuity fault at the point of terminal contact 10b is detected and the shape memory alloy member 34 is ohmically heated in a well-known manner response to the detected value.

In the case of Embodiment 3, when the shape memory alloy member 34 is ohmically heated, the shape memory alloy member 34, due to its properties, is displaced (deformed) as shown in FIG. 14 (B).

When the shape memory alloy member 34 is displaced, a gap S, such as the one illustrated in the drawing, appears between the shape memory alloy member 34 and the cavity 15 or, in a variation, between the shape memory alloy member 34 and the slit 12. The lubricant C containing dispersed metal nanoparticles B, which has been held in the cavity 15, flows through this gap S into the slit 12 below and is then dropped onto the point of terminal contact 10b of the terminal 10.

As a result, the metal nanoparticles B are fused under the action of the “dielectrophoretic forces,” etc., and interlinked into a unitary piece of metal, through which the electric current flows, thereby making it possible to effect a “self-repairing” action.

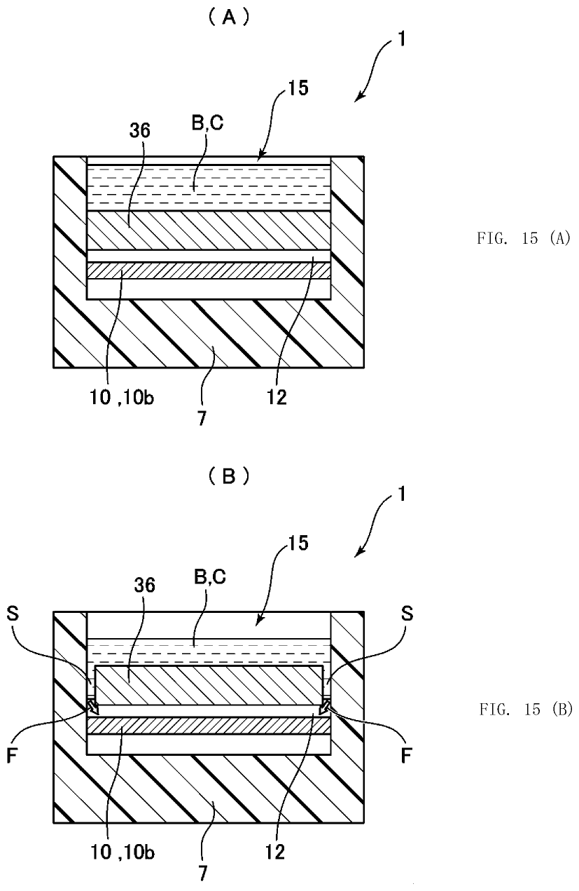

A self-repairing connector according to Embodiment 4 of the present invention will now be described with reference to FIGS. 15 (A) and 15 (B). FIG. 15 (A) is a schematic cross-sectional view, as seen from the same position as line A-A of FIG. 3, diagrammatically illustrating the configuration of the housing, holding portion and dispersion-dropping structure of the connector according to Embodiment 4 of the present invention, and FIG. 15 (B) is a schematic cross-sectional view illustrating, similar to the explanatory view of FIG. 15 (A), the operation of the connector according to Embodiment 4 of the present invention shown in FIG. 15 (A).

The description hereinbelow will focus only on points of difference from Embodiments 1 to 3 described above, and configurations in common with Embodiments 1 to 3 will be described using the same reference numerals.

First, as shown in FIG. 15 (A), in Embodiment 4 of the present invention, a dispersion holding cavity (holding portion) 15 is formed in the housing 7 in a manner similar to Embodiments 2 and 3 described above. The lubricant (dispersion) C containing dispersed metal nanoparticles B is stored directly in this cavity 15 such that the dispersion C is held in the cavity 15.

In Embodiment 4, a member 36 with a different coefficient of linear expansion is provided in each of the multiple slits 12 serving as fluid communication portions in a manner preventing downward leakage of the lubricant C such that the lubricant C is kept within the cavity 15.

It should be noted that, as a variation, one or more members 36 with a different coefficient of linear expansion may be provided on the lower face of the cavity 15, i.e., the bottom face of the cavity 15 including the top edges of the above-described multiple slits 12. In this variation, the one or more members 36 with a different coefficient of linear expansion are provided in a manner to cover the entire bottom face of the cavity 15 while keeping the lubricant C containing dispersed metal nanoparticles B within the cavity 15 (in a manner preventing downward leakage).

The operation of Embodiment 4 will now be described with reference to FIG. 15 (B).

Similar to the above-described Embodiment 2, Embodiment 4 makes use of the heat generated as a result of an increase in the value of contact resistance at the point of terminal contact 10b in response to a continuity fault between the terminals 10, 24.

First, as shown in FIG. 15 (B), along with being transferred to the cavity 15, the heat generated at the point of terminal contact 10b is transmitted to the member 36 with a different coefficient of linear expansion, at which point the member 36 with a different coefficient of linear expansion is displaced (deformed) as shown in FIG. 15 (B) because of the different coefficient of linear expansion.

When the member 36 with a different coefficient of linear expansion is displaced, gaps S, such as the ones illustrated in the drawing, appear between the member 36 with a different coefficient of linear expansion and the slit 12 or, in a variation, between the member 36 with a different coefficient of linear expansion and the cavity 15. The lubricant C containing dispersed metal nanoparticles B, which has been held in the cavity 15, flows through these gaps S into the slit 12 below and, furthermore, is dropped onto the point of terminal contact 10b of the terminal 10.

As a result, as described above, the metal nanoparticles B are fused under the action of the “dielectrophoretic forces,” etc., and interlinked into a unitary piece of metal, through which the electric current flows, thereby making it possible to effect a “self-repairing” action.

It should be noted that, as a variation of Embodiments 2 to 4, the above-described bimetallic member 34, shape memory alloy member 34 and/or member 36 with a different coefficient of linear expansion may be combined as appropriate and included as part of the dispersion-dropping structure.

Here, in the above-described Embodiments 1 to 4 and variations thereof, the receiving cavity 14 is disposed above the terminals 10 (at a location directly above them in the drawings). By contrast, in a further variation, the receiving cavity (14, 15) may be provided at a location spaced away from the terminals 10 when seen in plan view. In such a case, a predetermined flow passage (e.g., a groove or conduit) may be formed connected to the holding cavity in order for the released dispersion C of metal nanoparticles B to flow to the point of terminal contact 10b. In particular, in such a variation, the holding cavity or predetermined flow passage may be formed, for example, at a location other than the housing.

In addition, ribs may be provided between adjacent terminals 10 in order to prevent shorting between the terminals 10 resulting from the dispersion C flowing to adjacent terminals 10 when being dropped onto each point of terminal contact 10b. Such ribs are preferably provided in the housing 6, 7.

The operation and effects of the self-repairing connector according to Embodiments 1 to 4 of the present invention and variations thereof will be explained below.

First, the self-repairing connector 1 according to Embodiments 1 to 4 of the present invention and variations thereof is a self-repairing connector which, along with mating with a receptacle connector 20 and placing respective terminals 10, 24 in electrical communication, is adapted to self-repair continuity faults between the respective terminals 10, 24, said connector comprising a housing 6 formed of a non-conductive material and terminal members 10 that have one end thereof retained in the housing 6, 7 and make contact with the terminals 24 of the receptacle connector 20 via points of terminal contact 10b, wherein a holding cavity (holding portion) 14, 15 holding a dispersion C of metal nanoparticles B is formed in the housing 6, slit portions 12 serving as fluid communication portions effecting fluid communication between the holding cavity 14, 15 and the terminal members 10 are formed in the housing 6, and the holding cavity 14, 15 is disposed such that the dispersion C of metal nanoparticles B is dropped onto the point of terminal contact 10b if a continuity fault occurs at the point of terminal contact 10b, that is, if a continuity fault occurs between the respective terminals 10, 24.

In accordance with the thus-configured embodiment of the present invention and a variation thereof, upon occurrence of a continuity fault between the respective terminals 10, 24, the metal nanoparticles B contained in the dispersion C that is dropped onto the points of terminal contact 10b aggregate in the continuity fault area under the action of the electric field generated as a consequence of the continuity fault and interlink the terminals 10, 24, thereby making it possible to self-repair a continuity fault in the event of a continuity fault occurring at the point of terminal contact 10b.

In addition, in accordance with Embodiments 1 to 4 of the present invention and variations thereof, fluid communication paths 10c, 10d intended for fluid communication of the dispersion C of metal nanoparticles B are formed at the points of terminal contact. These fluid communication paths 10c, 10d formed in the terminal members 10 are one or more apertures 10c of a rectangular cross-section or apertures 10d of a circular cross-section extending through the terminal members 10 in the vertical direction.

In accordance with the thus-configured Embodiments 1 to 4 of the present invention and variations thereof, the dispersion C of metal nanoparticles B dropped onto the terminal members 10 via the slit portions 12 of the housing 6 can be dropped onto the points of terminal contact 10b in an efficient manner. For example, rather than allowing the dispersion C of metal nanoparticles B to flow to the point of terminal contact 10b via the lateral faces of the terminal members 10, the dispersion can be dropped directly along the shortest path through the aperture portions 10c, 10d of the terminal members 10.

In addition, in accordance with Embodiment 1 of the present invention and a variation thereof, the holding cavity 14 of the housing 6 is formed in a manner to hold multiple microcapsules MC encapsulating the dispersion C of metal nanoparticles B within a membrane A, the membrane A disintegrates and the encapsulated dispersion C of metal nanoparticles B is released when the temperature of the microcapsules MC is raised to a predetermined temperature, and the cavity 14 of the housing 6 is formed at a location adjacent to and overlying the slit portions 12, i.e., the fluid communication portions in the housing 6, in such a manner that, upon occurrence of a continuity fault at the point of terminal contact 10b, the heat generated at the point of terminal contact 10b as a consequence of this continuity fault is transferred to the cavity 14 and the membrane A of the microcapsules MC held therein disintegrates and the released dispersion C of metal nanoparticles B is dropped onto the point of terminal contact 10b via the slits 12, i.e. the fluid communication portions of the housing 6, and the aperture portions 10c, 10d, i.e., the fluid communication paths of the terminal members 10.

In accordance with the thus-configured Embodiment 1 and a variation thereof, upon occurrence of a continuity fault at the point of terminal contact 10b, the membrane A of the microcapsules MC is disintegrated by the heat generated as a consequence of this continuity fault, and the released dispersion C of metal nanoparticles B is dropped onto the point of terminal contact 10b via the slit portions 12 of the housing 6 and the aperture portions 10c, 10d of the terminal members 10, thereby making it possible to self-repair a continuity fault in a more efficient manner upon occurrence of a continuity fault at the point of terminal contact 10b.

In addition, in accordance with Embodiment 1 of the present invention and a variation thereof, the holding cavity 14 of the housing 6 is formed in a manner to hold multiple microcapsules MC encapsulating the dispersion C of metal nanoparticles B within a membrane A, the membrane A disintegrates and the encapsulated dispersion C of metal nanoparticles B is released when the temperature of the microcapsules MC is raised to a predetermined temperature, and a film heater 30, i.e., a heat source used for heating the microcapsules MC held in the cavity 14, is provided in the housing 6, adjacent to the microcapsule-holding cavity 14, in such a manner that the membrane A of the microcapsules MC disintegrates under the heat of the film heater 30 and the released dispersion C of metal nanoparticles B is dropped onto the point of terminal contact 10b via the slit portions 12, i.e., the fluid communication portions of the housing 6, and the aperture portions 10c, 10d, i.e., the fluid communication paths of the terminal members 10.

In accordance with the thus-configured embodiment of the present invention and a variation thereof, upon occurrence of a continuity fault at the point of terminal contact 10b, the membrane A of the microcapsules MC is disintegrated by the heat generated by the film heater 30, and the released dispersion C of metal nanoparticles B is dropped onto the point of terminal contact 10b via the slit portions 12 of the housing 6 and the aperture portions 10c, 10d of the terminal members 10, thereby making it possible to self-repair a continuity fault in a more efficient manner upon occurrence of a continuity fault at the point of terminal contact 10b.

In addition, in accordance with Embodiment 1 of the present invention and a variation thereof, the film heater 30, i.e. the heat source, is configured to operate upon detection of an increase in the value of resistance due to a continuity fault of a terminal member 10 of the connector 1 and a terminal 24 of the receptacle connector 20 detected by a predetermined detector.

In addition, the slit portions 12, i.e., the fluid communication portions of the housing 6, are slit portions 12 that accommodate the terminal members 10 by sandwiching them on the left and right.

In addition, the self-repairing connector 1 is a plug connector having a cable 4 connected thereto, and the receptacle connector 20 is mounted on a predetermined board 26.

In addition, in accordance with Embodiments 2 to 4 of the present invention and variations thereof, the holding cavity (holding portion) 15 of the housing 7 is formed in a manner to store and hold the dispersion C of metal nanoparticles B (see FIGS. 14, 15), and the self-repairing connector 1 comprises a bimetallic member 34, a shape memory alloy member 34, and/or a member 36 with a different coefficient of linear expansion provided in the holding cavity 15 or in the slit portions 12, i.e., in the fluid communication portions, in a manner to drop the dispersion C of metal nanoparticles B held in the holding cavity 15 upon occurrence of a continuity fault between the respective terminals 10, 24.

In accordance with the thus-configured Embodiments 2 to 4 and variations thereof, the dispersion C of metal nanoparticles B can be dropped onto the points of terminal contact 10b in an efficient manner.

In addition, in Embodiments 1 to 4 and variations thereof, the above-described self-repair mechanism/dispersion-dropping structure, which comprises the holding cavity 14, 15, is provided in the plug connector 1, which is not susceptible to the effects of heat, rather than in the receptacle connector 20, which is mounted on the board 26 and is susceptible to heat.

It should be noted that individual embodiments of the present invention are not independent and can be implemented in combinations with one another as appropriate. In addition, the embodiments described above are illustrations intended to describe the present invention, and the present invention is not limited to these embodiments. The present invention can be implemented in various forms without deviating from the essence thereof.

### INDUSTRIAL APPLICABILITY

The inventive self-repairing connector can be used for a variety of applications, such as in extreme environments that are difficult to access for operators, e.g., nuclear power plants, facilities deployed on the ocean floor, satellite facilities in outer space, and the like, as well as for consumer applications.

### DESCRIPTION OF THE REFERENCE NUMERALS

1 Connector, plug connector, cable connector
6 Housing according to Embodiment 1
7 Housing according to Embodiments 2 to 4
10 Terminals, terminal members
10a Curved portion
10b Point of terminal contact
10c Slit portion, aperture portion (fluid communication path)
10d Aperture portion (fluid communication path)
12 Slit (fluid communication portion)
14 Microcapsule-holding cavity (holding portion)
15 Dispersion holding cavity (holding portion)
20 Receptacle connector (counterpart connector)
24 Terminals, counterpart terminals
30 Film heater
34 Bimetal according to Embodiment 2, shape memory alloy according to Embodiment 3
36 Member with different coefficient of linear expansion according to Embodiment 4
MC Microcapsules
A Membrane
B Metal nanoparticles
C Lubricant, dispersion
F Direction of dropping of the lubricant containing dispersed metal nanoparticles
H Heat, direction of heat transfer
S Gap

1. A self-repairing connector which, along with mating with a counterpart connector and placing respective terminals in electrical communication, is adapted to self-repair continuity faults between the respective terminals, the connector comprising:
a housing formed of a non-conductive material, and
terminal members having one end thereof retained in the aforementioned housing and making contact with the terminals of the aforementioned counterpart connector via points of terminal contact, wherein:
a holding portion holding a dispersion of metal nanoparticles is formed in the aforementioned housing,
fluid communication portions effecting fluid communication between the aforementioned holding portion and the aforementioned terminal members are formed in the aforementioned housing, and
the dispersion of metal nanoparticles held in the aforementioned holding portion is dropped onto the aforementioned points of terminal contact in a predetermined case.

2. The self-repairing connector according to claim 1, wherein fluid communication paths intended for fluid communication of the aforementioned dispersion of metal nanoparticles are formed at the location of the aforementioned points of terminal contact in the aforementioned terminal members.

3. The self-repairing connector according to claim 2, wherein the fluid communication paths formed in the aforementioned terminal members are a single aperture portion or a plurality of aperture portions of a rectangular cross-section or aperture portions of a circular cross-section disposed through the aforementioned terminal members in the vertical direction.

4. The self-repairing connector according to claim 1, wherein the aforementioned holding portion of the housing is formed in a manner to hold a plurality of microcapsules encapsulating the aforementioned dispersion of metal nanoparticles within a membrane,
the membrane disintegrates and the encapsulated dispersion of metal nanoparticles is released when the temperature of the aforementioned microcapsules is raised to a predetermined temperature,
the aforementioned holding portion of the housing is formed at a location adjacent to and overlying the aforementioned fluid communication portions in the aforementioned housing in such a manner that, upon occurrence of a continuity fault at the aforementioned point of terminal contact, the heat generated at the aforementioned point of terminal contact as a consequence of this continuity fault is transferred to the aforementioned holding portion and the membrane of the microcapsules held therein disintegrates and the released dispersion of metal nanoparticles is dropped onto the aforementioned point of terminal contact via the fluid communication portions of the aforementioned housing and the fluid communication paths of the aforementioned terminal members, and
the aforementioned predetermined case is when, upon occurrence of a continuity fault at the aforementioned point of terminal contact, the heat generated at the aforementioned point of terminal contact as a consequence of this continuity fault is transferred to the aforementioned holding portion.

5. The self-repairing connector according to claim 1, wherein the aforementioned holding portion of the housing is formed in a manner to hold a plurality of microcapsules encapsulating the aforementioned dispersion of metal nanoparticles within a membrane,
the membrane disintegrates and the encapsulated dispersion of metal nanoparticles is released when the temperature of the aforementioned microcapsules is raised to a predetermined temperature,
a heat source used for heating the microcapsules held in the aforementioned holding portion is provided in the aforementioned housing adjacent to the aforementioned holding portion in such a manner that the membrane of the microcapsules disintegrates under the heat of the aforementioned heat source, and the released dispersion of metal nanoparticles is dropped onto the aforementioned point of terminal contact via the fluid communication portions of the aforementioned housing and the fluid communication paths of the aforementioned terminal members, and
the aforementioned predetermined case is when the aforementioned heat source is in operation.

6. The self-repairing connector according to claim 5, wherein the aforementioned heat source is configured to operate upon detection of an increase in the value of resistance due to a continuity fault of a terminal member of the aforementioned self-repairing connector and a terminal of the aforementioned counterpart connector detected by a predetermined detector.

7. The self-repairing connector according to claim 1, wherein the aforementioned holding portion of the housing is formed in a manner to store and hold the aforementioned dispersion of metal nanoparticles, and
a bimetallic member, a shape memory alloy member, and/or a member with a different coefficient of linear expansion configured to drop the dispersion of metal nanoparticles held in the aforementioned holding portion in the aforementioned predetermined case is provided in the aforementioned holding portion or the aforementioned fluid communication portions.

8. The self-repairing connector according to claim 1, wherein the aforementioned fluid communication portions of the housing are slit portions holding the aforementioned terminal members by sandwiching them in the left-to-right direction.

9. The self-repairing connector according to claim 1, wherein the aforementioned self-repairing connector is a plug connector, and the aforementioned counterpart connector is a receptacle connector mounted on a predetermined board.
